(19) United States
(12) Patent Application Publication
(10) Pub. No.: US 2015/0107647 A1
(43) Pub. Date: Apr. 23, 2015

(54) SOLAR CELL MODULE

(71) Applicant: USHIO DENKI KABUSHIKI KAISHA, Tokyo (JP)

(72) Inventor: Masaki Nakamura, Shizuoka (JP)

(21) Appl. No.: 14/520,862

(22) Filed: Oct. 22, 2014

(30) Foreign Application Priority Data
Oct. 23, 2013 (JP) 2013-220676

(51) Int. Cl. H02S 30/20

(52) U.S. Cl. CPC H02S 30/20
USPC 136/245

(57) ABSTRACT

A solar cell module that includes: a plurality of cylindrical solar cells; and a retaining member configured to retain each of the cylindrical solar cells and couple the cylindrical solar cells together. The retaining member separates the cylindrical solar cells away from each other, and allows any of the cylindrical solar cells to be displaced relative to adjacent one of the cylindrical solar cells.

### CROSS REFERENCE TO RELATED APPLICATIONS

This application claims the benefit of Japanese Priority Patent Application JP2013-220676 filed on Oct. 23, 2013, the entire contents of which are incorporated herein by reference.

### BACKGROUND

The invention relates to a solar cell module that includes a plurality of cylindrical solar cells.

Solar power generation is a principal renewable energy source that has now been put into widespread, full-fledged use. Solar cells can be classified into a crystalline solar cell, a thin-film-based solar cell, a compound-based solar cell, an organic-based solar cell, and so forth. The crystalline solar cell may be typified by that which utilizes polycrystalline silicon. The thin-film-based solar cell may utilizes an amorphous silicon thin-film or a microcrystalline silicon thin-film. The compound-based solar cell may be that which is based on CIGS (Copper Indium Gallium Selenide). In most cases, those solar cells are of a panel type (or of a flat-plate type) in terms of their overall shapes; however, there exist solar cells that are of a cylindrical type, one example of which is a cylindrical dye-sensitized solar cell.

A dye-sensitized solar cell is a solar cell that generates electricity through exciting a sensitizing dye attached to a surface of a semiconductor by sunlight and injecting electrons released by the excitation into the semiconductor. The dye-sensitized solar cell does not involve use of a vacuum process unlike the crystalline solar cell, the thin-film-based solar cell, or the like, and thus enables a significant reduction in manufacturing cost. The dye-sensitized solar cell also makes installation cost extremely inexpensive due to its easier transportation and handling. On the other hand, the dye-sensitized solar cell is considered to be disadvantageous in terms of low conversion efficiency; however, a proposal has been made to increase the conversion efficiency by forming the solar cell into a cylindrical shape as a whole, as disclosed in Japanese Patent No. 4840540 and Japanese Unexamined Patent Application Publication Nos. 2003-77550 and 2007-12545. The expectation is therefore placed on practical application of the dye-sensitized solar cell as one of the next-generation solar cells.

### SUMMARY

FIGS. 15A-1, 15A-2, 15B-1 and 15B-2 schematically illustrate an advantage of a cylindrical solar cell including a cylindrical dye-sensitized solar cell, in which a state of receiving sunlight by a panel (flat plate) solar cell is compared with that by the cylindrical solar cell. In FIGS. 15A-1 and 15B-1 each illustrates a case where the sunlight is incident from directly above, whereas FIGS. 15A-2 and 15B-2 each illustrates a case where the sunlight is incident obliquely from above.

It is known that the conversion efficiency decreases in the panel solar cell when the sunlight is incident obliquely (FIG. 15A-2) as compared with the case when the sunlight is incident vertically (FIG. 15A-1). In contrast, the cylindrical solar cell exercises basically the same generation performance in any direction of incidence around 360 degrees, thus making it possible to achieve the conversion efficiency equivalent to that of the vertical incidence (FIG. 15B-1) even with the oblique incidence FIG. 15B-2). Hence, a total amount of power generation in the cylindrical solar cell per day is higher than that in the panel solar cell per day when those solar cells are arranged to occupy the same space, since the cylindrical solar cell is higher in conversion efficiency than the panel solar cell.

FIG. 16 shows a result of a simulation experiment that confirmed the superiority of the cylindrical solar cell, in which the cylindrical dye-sensitized solar cell is taken as an example. In the experiment conducted, a panel dye-sensitized solar cell and a cylindrical dye-sensitized solar cell were fabricated. The panel dye-sensitized solar cell and the cylindrical dye-sensitized solar cell were both made to have the same length as one another, and a width of the panel dye-sensitized solar cell was made the same as a diameter of the cylindrical dye-sensitized solar cell. Configurations of photoelectrode, etc., were made basically the same between those solar cells.

In FIG. 16, a vertical axis shows an amount of power generation (in a relative value) per unit time, while a horizontal axis shows time. In this experiment, an amount of power generation per unit time was simulated for each hour from sunrise to sunset on the basis of a solar simulator, where intensity of sunlight was assumed as that around 20th of March in Japan and AM (Air Mass) was 1.5. As is apparent from FIG. 16, the cylindrical solar cell is larger in amount of power generation than the panel solar cell overall, and is large in amount of power generation especially in the morning and in the late afternoon where an altitude of the sun is both low.

The cylindrical solar cell is therefore superior to the panel solar cell in incidence angle characteristics of the sunlight. The fact that the conversion efficiency becomes lower in the oblique incidence than in the vertical incidence also applies to a crystalline panel solar cell, a thin-film-based panel solar cell, or the like in general. Hence, the cylindrical solar cell, which is superior in incidence angle characteristics, is potentially comparable to the panel solar cell in terms of a power generation efficiency in total per day (or per year) during which the incidence angle varies in diversity.

As for dye-sensitized solar cells, the panel dye-sensitized solar cell has been partly put into practical use. On the other hand, the cylindrical dye-sensitized solar cell is currently at a stage of research and development, and no specific proposal has been made yet on a configuration of a module in practical use of the cylindrical dye-sensitized solar cell. In view of the configuration of the module for the practical use of the cylindrical dye-sensitized solar cell, easy transportation and installation are important factors.

It is desirable to provide a solar cell module capable of achieving easy transportation and installation.

A solar cell module according to an embodiment of the invention includes: a plurality of cylindrical solar cells; and a retaining member configured to retain each of the cylindrical solar cells and couple the cylindrical solar cells together. The retaining member separates the cylindrical solar cells away from each other, and allows any of the cylindrical solar cells to be displaced relative to adjacent one of the cylindrical solar cells.

Advantageously, the retaining member may include a transmission path configured to send electricity generated by the cylindrical solar cells.

Advantageously, the retaining member may attachably and detachably retain the cylindrical solar cells.

Advantageously, the retaining member may displace the cylindrical solar cells to allow the solar cell module to be rolled up as a whole and the cylindrical solar cells to be bundled.

Advantageously, the retaining member may include a wire.

Advantageously, the cylindrical solar cells may form a plurality of cell units each including two of the cylindrical solar cells and a converter, in which the two cylindrical solar cells are connected in series, and the converter is configured to convert an output voltage derived from the two cylindrical solar cells, and the retaining member may retain the cell units and couples the cell units together.

Advantageously, each of the cylindrical solar cells may include a dye-sensitized solar cell.

According to the solar cell module in any of the above-described embodiments of the invention, the retaining member retains each of the cylindrical solar cells and couples the cylindrical solar cells together. The retaining member separates the cylindrical solar cells away from each other, and allows any of the cylindrical solar cells to be displaced relative to adjacent one of the cylindrical solar cells. Hence, it is possible to achieve easy transportation and installation.

In one embodiment where the retaining member includes the transmission path configured to send the electricity generated by the cylindrical solar cells, a path for transmitting electricity does not necessarily have to be provided separately. Hence, it is possible to achieve a simplified structure and reduced cost.

In one embodiment where the retaining member attachably and detachably retains the cylindrical solar cells, it is possible to, when deterioration or failure occurs in one of the cylindrical solar cells, perform replacement of only that cylindrical solar cell. Hence, it is possible to eliminate the necessity of replacing the entire solar cell module.

In one embodiment where the retaining member displaces the cylindrical solar cells to allow the solar cell module to be rolled up as a whole and the cylindrical solar cells to be bundled, it is possible to allow the solar cell module to be compact upon transportation, storage in a warehouse, or the like, and thus to reduce costs in this regard.

In one embodiment where the retaining member includes the wire, the cylindrical solar cells are displaceable in any direction more freely. Hence, it is possible to further increase a degree of freedom as to a shape of an installation site.

In one embodiment where the cylindrical solar cells form the plurality of cell units each including two of the cylindrical solar cells and the converter, in which the two cylindrical solar cells are connected in series, and the converter is configured to convert the output voltage derived from the two cylindrical solar cells, and the retaining member retains the cell units and couples the cell units together, it is possible to draw output power, derived from the two cylindrical solar cells connected in series, at a standardized value. Also, it is possible to perform replacement of the cell unit having such a function on a cell unit basis.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate some example embodiments and, together with the specification, serve to explain the principles of the invention.

FIG. 1 is a schematic perspective view illustrating a solar cell module according to a first embodiment of the invention.

FIGS. 2A and 2B are schematic cross-sectional views illustrating a cylindrical dye-sensitized solar cell included in the solar cell module according to the example embodiment, in which FIG. 2A is a schematic cross-sectional view taken along a plane perpendicular to a longitudinal direction of the cylindrical dye-sensitized solar cell, and FIG. 2B is a schematic cross-sectional view taken along a plane in the longitudinal direction thereof.

FIGS. 3A-1, 3A-2, 3B-1 and 3B-2 schematically illustrate an advantage of the solar cell module according to the example embodiment.

FIG. 4 is a schematic cross-sectional view illustrating a retaining structure of each of the cylindrical solar cells in the solar cell module according to the example embodiment.

FIG. 5 is a schematic cross-sectional view illustrating a retaining structure of each of the cylindrical solar cells in the solar cell module according to the example embodiment.

FIG. 6 is a front view illustrating a state in which the solar cell module according to the example embodiment is installed on a curved roof.

FIG. 7 is a schematic perspective view describing an advantage of the solar cell module according to the example embodiment from the viewpoint of transportation.

FIG. 8 illustrates a distinctive part of a solar cell module according to a second embodiment.

FIG. 9 schematically illustrates an example of an array pattern of cylindrical solar cells in the solar cell module according to the second embodiment.

FIG. 10 is a schematic cross-sectional view illustrating a retaining structure of the cylindrical solar cells in the array pattern illustrated in FIG. 9.

FIG. 11 schematically illustrates another example of the array pattern of the cylindrical solar cells.

FIG. 12 schematically illustrates yet another example of the array pattern of the cylindrical solar cells.

FIG. 13 is a schematic perspective view illustrating a distinctive part of a solar cell module according to a third embodiment.

FIGS. 14A and 14B schematically illustrate other examples of a retaining member.

FIGS. 15A-1, 15A-2, 15B-1 and 15B-2 schematically illustrate an advantage of a cylindrical solar cell such as a cylindrical dye-sensitized solar cell, in which a state of receiving sunlight by a panel (flat plate) solar cell is compared with that by the cylindrical solar cell.

FIG. 16 shows a result of a simulation experiment that confirmed the superiority of the cylindrical solar cell, in which the cylindrical dye-sensitized solar cell is taken as an example.

### DETAILED DESCRIPTION

Some example embodiments of the invention are described in detail below with reference to the accompanying drawings.

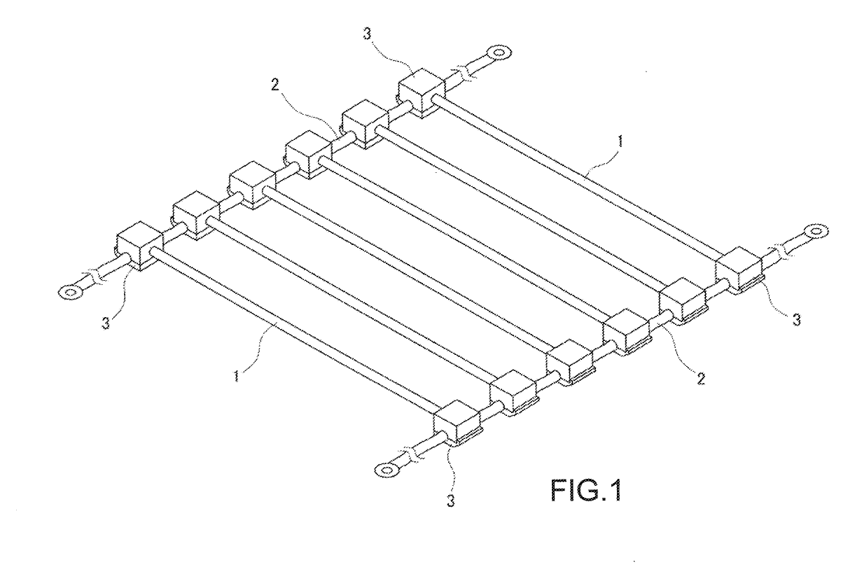

FIG. 1 is a schematic perspective view of a solar cell module according to a first embodiment of the invention. Referring to FIG. 1, the solar cell module includes a plurality of cylindrical solar cells 1. In the following, each of the cylindrical solar cells 1 is simply referred to as a “cylindrical cell 1” in order to distinguish the cylindrical solar cell 1 from the solar cell module. Also, the term “cylindrical cell” refers to a single cylindrical member that functions as a solar cell. The term “cell” is often used in the sense of an element in the minimum unit that performs generation of power. In the following description, however, the term “cylindrical cell” is not necessarily limited to the meaning of the term “cell” in the above-described sense, and may refer to a cylindrical member that includes a collection of a plurality of such cells each serving as the element in the minimum unit that performs power generation.

As illustrated in FIG. 1, the plurality of cylindrical cells 1 are arranged laterally in a side-by-side fashion. In the present embodiment, the cylindrical cells 1 may be arranged such that respective longitudinal directions (axial directions of the cylinders) thereof are substantially parallel to one another. The cylindrical cells 1 are so retained by a retaining member at respective both ends thereof as to be separated away from one another and are coupled together by the retaining member.

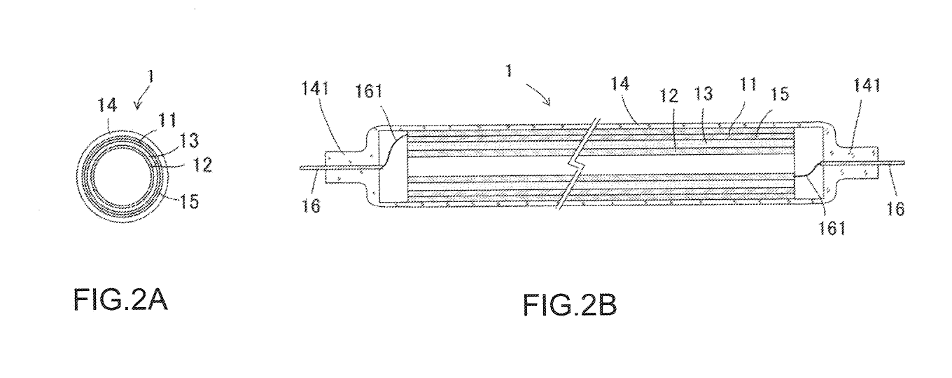

In the present embodiment, the solar cell module may be a dye-sensitized solar cell module, and each of the cylindrical cells 1 may be a dye-sensitized solar cell. FIGS. 2A and 2B are schematic cross-sectional views of the cylindrical cell 1 included in the solar cell module according to the present embodiment, in which FIG. 2A is a schematic cross-sectional view taken along a plane perpendicular to the longitudinal direction of the cylindrical cell 1, and FIG. 2B is a schematic cross-sectional view taken along a plane in the longitudinal direction thereof. Referring to FIGS. 2A and 2B, the cylindrical cell 1 has a configuration in which a photoelectrode 11, a counter electrode 12, and an electrolyte layer 13 are provided inside a cylindrical transparent tube 14. The photoelectrode 11 has a dye, and the electrolyte layer 13 is interposed between the photoelectrode 11 and the counter electrode 12. Further, a collector electrode 15 is provided inside the transparent tube 14 at an outer side of the photoelectrode 11.

The transparent tube 14 may be made of silica glass in the present embodiment. Alternatively, the transparent tube 14 may be made of any other material such as, but not limited to, borosilicate glass or soda glass.

The photoelectrode 11 has a configuration in which the dye is attached to a semiconductor. The semiconductor may preferably be an n-type semiconductor, and may be made of a material such as, but not limited to, a metal oxide or a metal sulfide. Examples of the metal oxide may include a titanium oxide and a tin oxide. The metal sulfide may be zinc sulfide. The dye may be any dye without particular limitation as long as the dye absorbs light from a visible range to an infrared range. Examples of such a dye may include an organic dye and a metal complex. More specific but non-limiting examples of the dye may include: a cyanine-based dye such as, but not limited to, merocyanine, quinocyanine, or criptocyanine; and a metal complex such as, but not limited to, copper, ruthenium, osmium, iron, or zinc.

The electrolyte layer 13 may be a liquid electrolyte layer in this embodiment, and may be an iodine-based electrolyte layer, a bromine-based electrolyte layer, or the like. The electrolyte layer 13 is enclosed in the transparent tube 14 at an amount by which at least a region between the photoelectrode 11 and the counter electrode 12 is filled.

The counter electrode 12 is made of a conductive material, and may be preferably high in corrosion resistance to a material of the electrolyte layer 13. For example, the counter electrode 12 may be made of a material such as, but not limited to, titanium or platinum. In the present embodiment, the counter electrode 12 may be cylindrical in shape. As illustrated in FIGS. 2A and 2B, the respective members are coaxial with the transparent tube 14, being disposed in the order of the counter electrode 12, the photoelectrode 11, and the collector electrode 15 from the center. The collector electrode 15 may be made of an existing transparent conductive material such as, but not limited to, indium tin oxide (ITO). It is to be noted that a configuration may be permitted in theory where the collector electrode 15 is omitted as long as extraction of charges is possible only with use of the photoelectrode 11.

The collector electrode 15 may be formed by providing a transparent conductive film on the transparent tube 14 using a method such as, but not limited to, wet coating. The photoelectrode 11 may be formed by depositing semiconductor microparticles attached with the dye or sintering such microparticles, and may preferably have a porous structure. For forming methods and manufacturing methods of the respective members other than those described above, reference is made to Japanese Patent No. 4840540 and Japanese Unexamined Patent Application Publication Nos. 2003-77550 and 2007-12545.

As illustrated in FIG. 2B, both ends of the transparent tube 14 are sealed by a pair of sealing sections 141. The pair of sealing sections 141 serve to prevent leakage of the electrolyte layer 13 which may be in a form of liquid, and prevent harmful substances such as, but not limited to, water and air (oxygen) from entering inside the transparent tube 14. The pair of sealing sections 141 may be formed through heating the both ends of the transparent tube 14 and squashing the both ends with application of pressure (pressure crushing) under a state in which the both ends are softened. For the detail on the sealing, reference is made to Japanese Patent No. 4840540 and description thereof is omitted herein.

The sealing is performed with respective leads 16 being inserted through the both ends, whereby the pair of sealing sections 141 provide air-tightness and liquid-tightness in a state in which the respective leads 16 penetrate therethrough. Each of the leads 16 may have a rod-like shape in the present embodiment. Alternatively, the leads 16 each may be a wire-like lead, or may be a member in which two rod-like conductors or wire-shaped conductors are coupled to each other through a metal foil (see Japanese Patent No. 4840540).

The leads 16 on the respective ends of the transparent tube 14 serve to take out electricity generated inside the transparent tube 14, one of which being connected to the counter electrode 12 through a conducting wire 161 and the other being connected to the collector electrode 15 as illustrated in FIG. 2B. It is to be noted that, although unillustrated, one of the leads 16 is connected to the counter electrode 12 through a rod section so as to serve also as a retainer of the counter electrode 12 in the transparent tube 14.

A research conducted by the inventor revealed that a potential of a currently-available cylindrical solar cell has not been fully exploited from the viewpoint of conversion efficiency in a module as a whole. When taking the overall module into consideration, there is still room for further improvement in the conversion efficiency of the cylindrical solar cell.

As illustrated in FIG. 1, in the solar cell module according to the present embodiment, the plurality of cylindrical cells 1 are arranged laterally in a side-by-side fashion, but are not in contact with one another to provide a space between the transparent tubes 14. This feature makes it possible to further utilize characteristics of cylindrical solar cells and to further increase conversion efficiency thereof, in addition to achieving easier transportation and installation as well as inexpensive solar cell module, a description of which is provided below with reference to FIGS. 3A-1, 3A-2, 3B-1 and 3B-2. FIGS. 3A-1, 3A-2, 3B-1 and 3B-2 schematically illustrate an advantage of the solar cell module according to the present embodiment.

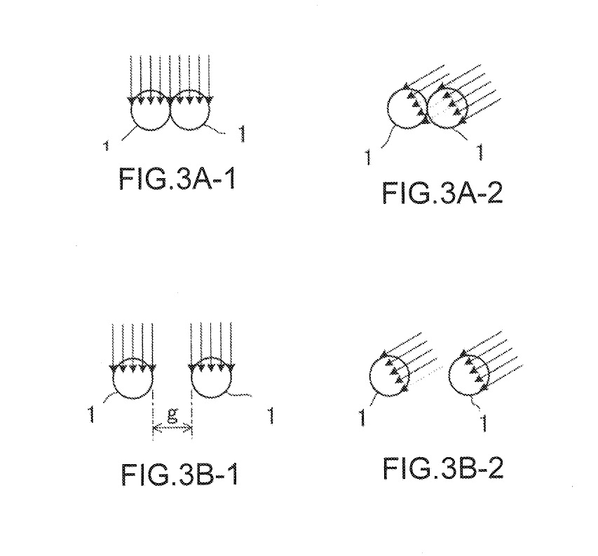

For comparison purposes, cases are illustrated partly in FIGS. 3A-1, 3A-2, 3B-1 and 3B-2 where the cylindrical cells 1 are so arranged laterally in a side-by-side fashion as to be in contact with one another. FIGS. 3A-1 and 3B-1 each illustrates a case where the sunlight is incident from directly above, or where the cylindrical cells 1 are arranged such that the respective longitudinal directions thereof are vertical as seen from the front and the sun is on the meridian. FIGS. 3A-2 and 3B-2 each illustrates a case where the sunlight is incident obliquely on each of the cylindrical cells 1. In each of FIGS. 3A-2 and 3B-2, a case may be assumed where the cylindrical cells 1 are arranged such that the respective longitudinal directions thereof are horizontal as seen from the front, or where the cylindrical cells 1 are arranged such that the respective longitudinal directions thereof are vertical as seen from the front and the sun is at any position other than the meridian.

When the sunlight is incident from directly above (or in the case where the cylindrical cells 1 are vertically arranged and the sun is at the meridian), an amount of sunlight incident on each of the cylindrical cells 1 and utilized for power generation does not vary virtually in either case of the contact arrangement illustrated in FIG. 3A-1 or the separated arrangement illustrated in FIG. 3B-1. When the sunlight, however, is incident obliquely, part of the sunlight is blocked by the adjacent cylindrical cell 1 in the contact arrangement as illustrated in FIG. 3A-2. In contrast, in the separated arrangement, blocking by the adjacent cylindrical cell 1 is prevented from occurring or hardly occurs. Hence, the amount of sunlight utilized for the power generation is greater in the separated arrangement than in the contact arrangement. The arrows arrayed at equal intervals in FIGS. 3A-1, 3A-2, 3B-1 and 3B-2 schematically denote the incident amount of sunlight. For example, when assuming that an amount of sunlight that enters a region corresponding to a diameter of the single cylindrical cell 1 is defined by five arrows, the amount of sunlight that enters the two cylindrical cells 1 may be that corresponding to seven arrows due to the blocking, when the sunlight is incident obliquely in the contact arrangement illustrated in FIG. 3A-2. In contrast, the amount of sunlight that enters the two cylindrical cells 1 may be that corresponding to nine arrows in the separated arrangement, for example.

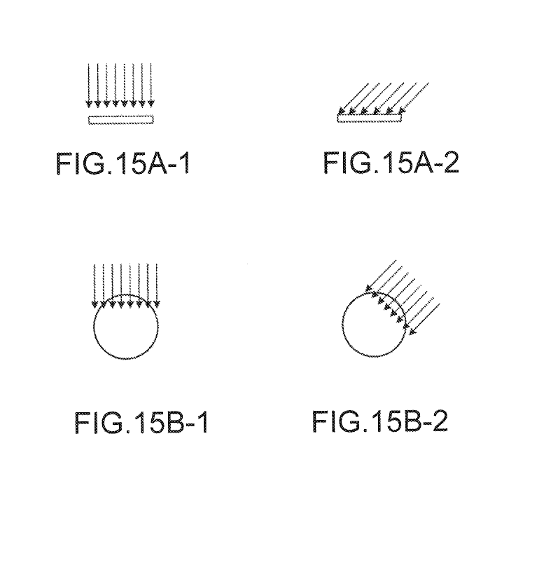

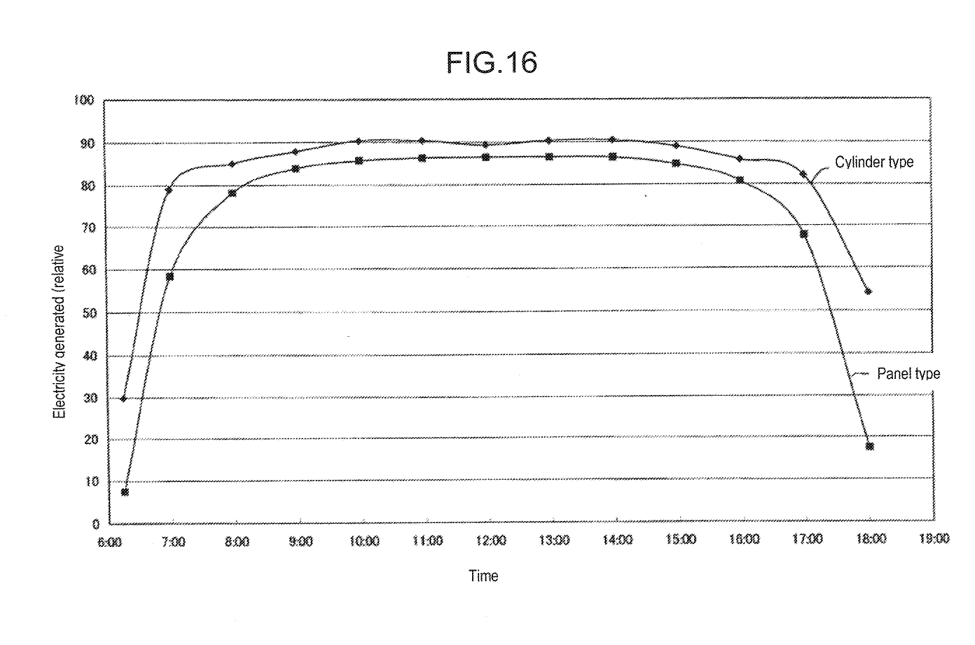

The states illustrated in FIGS. 3A-1 and 3B-1 are exceptional and in most cases, the sunlight is incident obliquely on the cylindrical cells 1. Hence, the configuration according to the present embodiment that adopts the separated arrangement is superior in that high conversion efficiency is achieved in most cases. The conversion efficiency here refers to a conversion efficiency based upon a comparison between the contact arrangement and the separated arrangement, per cylindrical cell 1. Note that, as is apparent from a comparison between FIGS. 15A-1 through 15B-2 and FIG. 3B-2, although an incident amount of sunlight does not vary substantially between the panel solar cell and the cylindrical cells 1 having the separated arrangement when the comparison is made per specific region, the conversion efficiency is higher in the cylindrical cells 1 having the separated arrangement, since an amount of light that enters the cylindrical cells 1 at an angle perpendicular to the photoelectrode 11 in each of the cylindrical cells 1 or at an angle near thereto is larger in the cylindrical cells 1 having the separated arrangement.

In the configuration of the separated arrangement described above, a separation spacing between the cylindrical cells 1 (denoted by “g” in FIG. 3B-1) is important in terms of a relationship between an occupying space and the conversion efficiency. If the separation spacing g is decreased to the extent equal to or over the limit, an amount of sunlight blocked by the adjacent cylindrical cell 1 may be increased, which may make it difficult to achieve sufficient effects derived from the increase in the conversion efficiency. On the other hand, increasing the separation spacing g to the extent equal to or over the limit may hardly achieve effects derived from the increase in the conversion efficiency any further, and may only result in an increase in occupying space of the solar cell module. Hence, the separation spacing g may preferably be that defined by the expression: 0.3φ≦g≦2φ where an outer diameter of the cylindrical cell 1 is φ, and more preferably be that defined by the expression: 1.0φ≦g≦1.5φ.

As described above, the configuration in which the cylindrical cells 1 are each arranged at a distance contributes to the improvement in the conversion efficiency from another perspective, a description of which is provided below.

The configuration in which the cylindrical cells 1 are each arranged at a distance according to the present embodiment allows the sunlight to pass through a clearance between the cylindrical cells 1. This means that the light is not completely blocked by the solar cell module even when the solar cell module is installed. Such a feature greatly differs from that of a panel solar cell module currently available.

Considering utilization of the feature where the light is allowed to pass partially, the solar cell module according to the present embodiment may be preferably arranged on a roof or on a wall that requires introduction of light. Examples of arrangement may include installation on a roof or a wall of a greenhouse such as, but not limited to, a plastic greenhouse or a conservatory, and installation on an opening or a window directed to introduction of light, such as that in an office building or a residence.

Also, the panel solar cell module is susceptible to an influence of wind. In contrast, the solar cell module according to the present embodiment is less susceptible to the influence of wind, since the wind is allowed to pass through the clearance between the cylindrical cells 1. Hence, the solar cell module according to the present embodiment does not necessarily require strong and robust installation, thereby making it possible to make installation costs inexpensive.

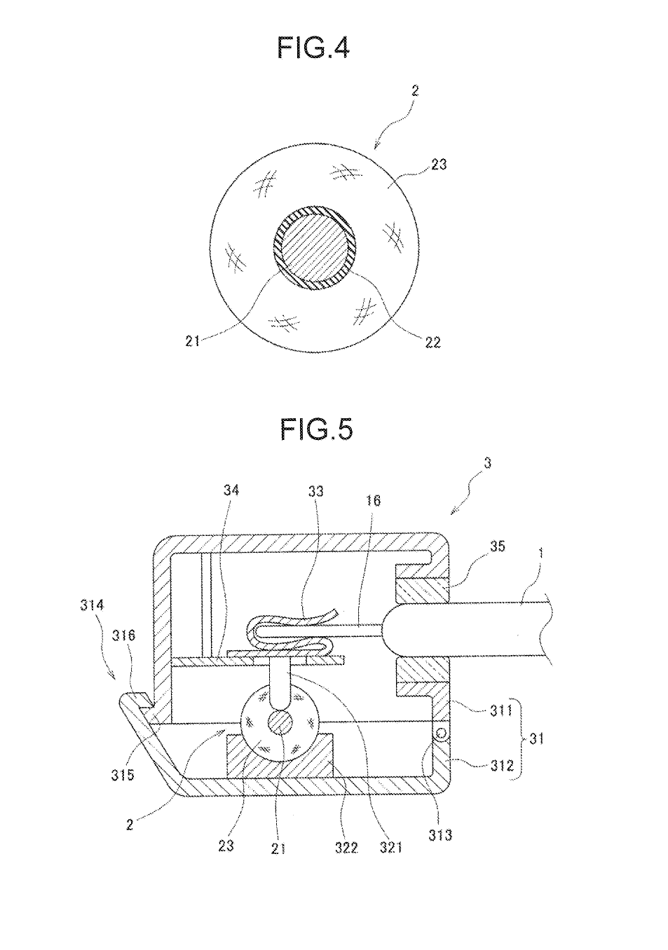

The cylindrical cells 1, so disposed as to be separated away from one another as described above, are each retained at the both ends by the retaining member and are thus coupled together by the retaining member. Each of the cylindrical cells 1 is retained by the retaining member in a displaceable fashion to some extent rather than being retained by the retaining member in a fixed fashion, a description of which is provided below with reference to FIGS. 1, 4, and 5. FIGS. 4 and 5 are each a schematic cross-sectional view illustrating a retaining structure of each of the cylindrical cells 1 in the solar cell module according to the present embodiment.

In the present embodiment, the retaining member retains each of the cylindrical cells 1, and may also form a transmission path (i.e., secures electrical conduction) that serves to send electricity generated by each of the cylindrical cells 1 to the outside. In one embodiment, the retaining member may be a wire 2. FIG. 4 illustrates a cross-sectional configuration of the wire 2 that serves as the retaining member.

As illustrated in FIG. 4, the wire 2 serving as the retaining member in one embodiment may have a configuration that includes a core 21, an insulation coating 22, and a reinforcement sheath 23. The insulation coating 22 covers the core 21, and the reinforcement sheath 23 covers the core 21 on the outside of the insulation coating 22. The core 21 may be a copper wire that may have a diameter in a range from about 1 mm to about 3 mm in cross-section. The insulating coating 22 is a thin coating provided on a surface of the core 21, and may be made of a material such as, but not limited to, enamel, polyurethane, or polyimide.

The reinforcement sheath 23 may be provided for one reason that the retaining member serves to retain the cylindrical cells 1 and thus a certain degree of mechanical strength is necessary. In the present embodiment, the reinforcement sheath 23 may be a wrap of a plurality of steal thin wires stranded around the core 21 covered with the insulating coating 22. In one embodiment, about ten to about thirty thin wires, which may be made of stainless steel and each having a diameter in a range from about 0 5 mm to about 2 mm in cross-section, may be stranded to wrap around the core 21 covered with the insulating coating 22 to form the reinforcement sheath 23. The reinforcement sheath 23 may have a thickness in a range from about 1 mm to about 2 mm. The wire 2 as a whole may have a diameter in a range from about 3 mm to about 7 mm.

The cylindrical cells 1 are each connected to the retaining member, which may be the wire 2 in one embodiment as described above, through connectors 3. FIG. 5 illustrates an example of a configuration of the connector 3. The connector 3 is provided with a case 31, a pair of crimping sections 321 and 322, a socket 33, and so forth. The case 31 includes a pair of covers 311 and 312. The crimping sections 321 and 322 are provided inside the case 31. The socket 33 is so provided as to be electrically connected to one of the crimping sections 321 and 322 (the crimping section 321 in the example embodiment illustrated in FIG. 5).

For description purposes, the pair of covers are here referred to as the upper cover 311 and the lower cover 312 in conformity to what is illustrated by way of example in FIG. 5. It is to be noted, however, that the terms “upper” and “lower” as used herein do not necessarily mean “upper” and “lower” in the actual usage sense. The upper cover 311 and the lower cover 312 are coupled to each other through a hinge 313 at respective first ends, whereas respective second ends thereof each serve as an engaging section 314. For example, the second end of the upper cover 311 may be formed with a projection 315, and the second end of the lower cover 312 may be formed with a hook section 316, as illustrated in FIG. 5. Each of the upper cover 311 and the lower cover 312 may be made of a resin having a certain degree of elasticity, and the hook section 316 may be hooked up to the projection 315 while slightly deforming the lower cover 312 to bring the hook section 316 and the projection 315 into engagement with each other, causing the upper cover 311 and the lower cover 312 to be closed and thus making those upper cover 311 and lower cover 312 difficult to come off easily.

The crimping sections 321 and 322 so crimp the wire 2, which may serve as the retaining member in one embodiment, as to interpose the wire 2 therebetween. In the present embodiment, the wire 2 serves to retain the cylindrical cells 1 as well as to bring those cylindrical cells 1 into electrical conduction; hence, the crimping sections 321 and 322 may serve to swage the wire 2. In one embodiment, when defining one of the crimping sections as a first crimping section 321 and defining the other as a second crimping section 322, the first crimping section 321 may be a plate-shaped member made of a metal and whose lower end is pointed, and the second crimping section 322 may have a shape of a concave that fits into a diameter of the wire 2.

The socket 33 is so provided as to be electrically connected to the first crimping section 321. Inside the upper cover 311 is a retaining plate 34 which is fixed therein and which may be made of a metal. The first crimping section 321 is formed on a bottom surface of the retaining plate 34 and extends downward therefrom. The socket 33 is fixed to a top surface of the retaining plate 34.

In the present embodiment, the socket 33 may be a plate spring. In one embodiment, a strip plate member made of a metal may be bent at the middle thereof to provide the substantially “U”-shaped socket 33 as illustrated in FIG. 5. A distance between both ends, facing the cylindrical cell 1 and bent to be brought close to each other, of the socket 33 may be slightly shorter than an outer diameter of the lead 16 of the cylindrical cell 1. In response to the insertion of the lead 16 into the socket 33, the socket 33 is slightly pressed to be widened thereby by virtue of its elasticity, and is brought into close contact with the lead 16 by virtue of its resilience.

A side surface on the first end side of the upper cover 311 includes an opening for attaching the cylindrical cell 1 and at which a cushion section 35 is provided. The cushion section 35 may be provided for the purposes of providing a buffer upon retaining the cylindrical cell 1 and preventing entering of water into the connector 3. The cushion section 35 may have a shape of a ring, and may be a member having a certain degree of elasticity, such as, but not limited to, a silicon resin. The cushion section 35 is a member capable of being in close contact with the end of the cylindrical cell 1 by virtue of its cushioning property, and has an inner diameter that fits into an outer diameter of the end of the cylindrical cell 1. In an alternative embodiment, a configuration may be employed in which a packing is provided on an inner surface of a metal ring, or an inner surface of the cushion section 35 is further provided with a packing. In the present embodiment, the cylindrical cell 1 is fixed to the cushion section 35 through adhesion using an adhesive, forming a configuration in which the connector 3 and the cylindrical cell 1 are integrated. In one embodiment, however, the cylindrical cell 1 may be provided detachably to the connector 3.

A positional relationship between the cushion section 35 and the socket 33 is dependent on a length of the lead 16 of the cylindrical cell 1. In one embodiment, the cushion section 35 and the socket 33 may be so disposed as to have a positional relationship in which the lead 16 is inserted at a sufficient length into the socket 33 when the cylindrical cell 1 is inserted into the cushion section 35, as illustrated in FIG. 5.

When coupling the cylindrical cell 1 to the wire 2 through the connector 3 as described above, the connector 3 is coupled to the wire 2, i.e., the wire 2 is placed on the second crimping section 322, and the upper cover 311 and the lower cover 312 are closed to bring the engaging section 314 into an engaged state. This causes the wire 2 to be interposed between the first crimping section 321 and the second crimping section 322, and is thus fixed while being swaged by the first crimping section 321 and the second crimping section 322. This in turn causes a tip of the first crimping section 321 to cut the reinforcement sheath 23 and the insulating coating 22 of the wire 2 to be in contact with the core 21, allowing the cylindrical cell 1 to be retained by and coupled to the wire 2 which serves as the retaining member in this embodiment. The “coupled” as used in this case means that the cylindrical cells 1 are coupled to one another.

It is to be noted that the upper cover 311 and the lower cover 312 each have a side surface formed with a semicircular notch that fits into a cross-sectional shape of the wire 2. When the wire 2 is crimped by the crimping sections 321 and 322 as described above, the wire 2 is interposed between those notched edges of the respective upper and lower covers 311 and 312.

It is to be also noted that FIG. 5 illustrates only the retaining structure corresponding to one of the ends of the cylindrical cell 1; however, the retaining structure is the same for the other end of the cylindrical cell 1 with the exception that the retaining structure of the other end is symmetric. When removing the cylindrical cell 1 from the wire 2, the engaging section 314 of the connector 3 is released from the engagement to open the upper cover 311 and the lower cover 312, so as to remove the cylindrical cell 1 together with the connector 3 from the wire 2.

As illustrated in FIG. 1, the solar cell module as a whole has a configuration in which the one ends of the respective cylindrical cells 1 disposed parallel to one another are mutually coupled through the wire 2, and the other ends of the respective cylindrical cells 1 are mutually coupled through another wire 2. In the present embodiment, the two wires 2 connect each of the cylindrical cells 1 electrically in parallel. Both ends of each wire 2 have respective terminals as illustrated in FIG. 1. Each of the terminals is connected to an unillustrated electricity storage upon installation of the solar cell module.

To give some examples of a specific configuration and installation of the solar cell module, in one embodiment where the cylindrical cell 1 has a diameter of about 10 mm without limitation, about fifty to about seventy five cylindrical cells 1 may be provided at a pitch in a range from about 5 mm to about 20 mm and retained by the pair of wires 2. One end of each of the wires 2 is connected to a system connection box through a power conditioner. Each wire 2 may have an overall length in a range from about 1 meter to about 2 meters. Such an overall length makes it easier for a single worker to perform an attachment work of the solar cell module.

Also, in one embodiment, two or more cylindrical cells 1 that are connected in series to one another may be used in the configuration illustrated in FIG. 1 instead of using each single cylindrical cell 1. A portion where such cylindrical cells 1 are connected in series to each other may be provided with a rod-like joint into which the leads 16 of the respective cylindrical cells 1 are inserted to be fixed to prevent detachment of those cylindrical cells 1.

Using the retaining member, which may be the wire 2 as described above, allows each of the cylindrical cells 1 to be displaceable in the solar cell module according to the present embodiment. The term “displaceable” as used herein means that one cylindrical cell 1 is capable of being displaced relative to adjacent another cylindrical cell 1. Such a configuration provides a multitude of advantages, some of which are described below.

One of some example advantages is that such a configuration increases a degree of freedom of installation sites and allows for inexpensive installation costs. As one configuration in which the plurality of cylindrical cells 1 are arranged to be separated away from one another, a configuration is contemplated in which a rectangular frame-shaped retaining member shaped like a window frame is used to retain the array of cylindrical cells 1 on the inner side of the frame. In this configuration, however, the rectangular frame is not deformable, and thus each of the cylindrical cells 1 is not displaceable. This configuration is similar to the panel solar cell module in that installation is relatively easy on a planar installation site such as a gabled roof but is difficult on a curved installation site. For the installation on the curved installation site, it is necessary to construct a structure that includes legs, beams, and so forth thereon in advance, and to fix the module having the above configuration on the structure.

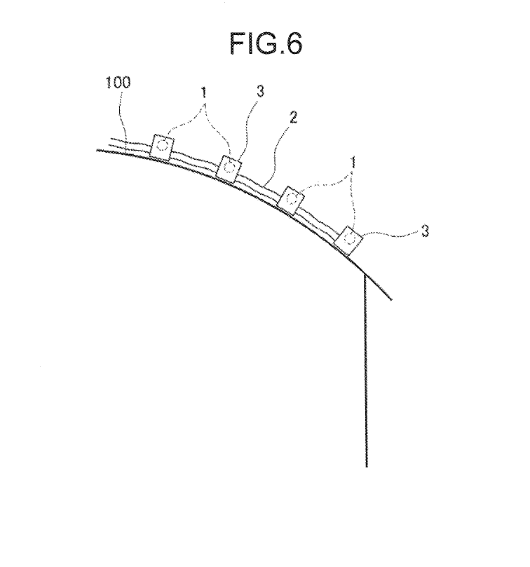

In contrast, the solar cell module according to the present embodiment makes it possible to so install the solar cell module as to follow a curved surface of the curved installation site while displacing each of the cylindrical cells 1. Hence, it is possible to install the solar cell module on the curved installation site without separately providing the large-scaled structure on the curved installation site, as illustrated in FIG. 6 that illustrates one example thereof. FIG. 6 is a front view illustrating a state in which the solar cell module according to the present embodiment is installed on a curved roof. As illustrated in FIG. 6, the solar cell module according to the present embodiment allows for easier installation on a curved roof 100. Such a curved roof 100 can often be seen on buildings including a gymnasium and public facilities without limitation. The solar cell module according to the present embodiment allows for easier installation likewise on any other curved roof such as, but not limited to, a corrugated roof.

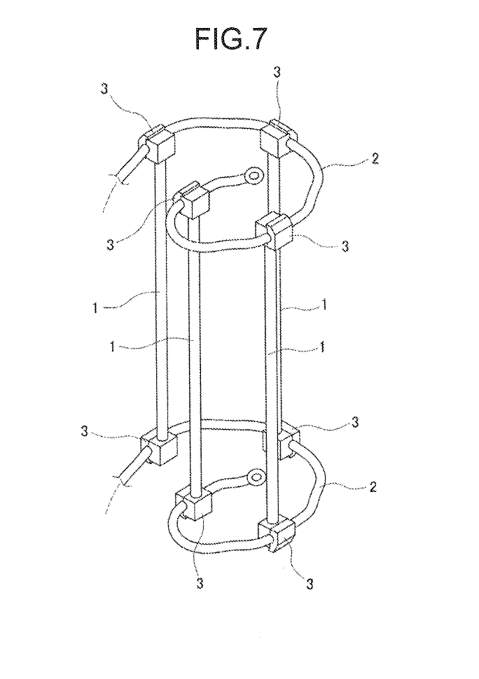

Additionally, allowing each of the cylindrical cells 1 to be displaceable also makes it possible to deform the solar cell module to a shape suitable for transportation as a whole upon transportation thereof, a description of which is provided below with reference to FIG. 7. FIG. 7 is a schematic perspective view describing an advantage of the solar cell module according to the present embodiment from the viewpoint of transportation.

Referring to FIG. 7, the present embodiment has the configuration in which the both ends of each of the cylindrical cells 1 are coupled together through the wire 2, making it possible for the solar cell module to be compact in dimension by rolling up the solar cell module. For example, the solar cell module may be rolled and folded up as illustrated in FIG. 7 while interposing an unillustrated cushioning material in between on an as-needed basis to prevent breakage of the solar cell module attributed to mutual contact of the cylindrical cells 1, allowing the thus-folded-up solar cell module to be transported while being stored inside a packaging such as, but not limited to, a cardboard case or a plastic case. Hence, it is possible to allow the solar cell module to be compact upon transportation even when the solar cell module(s) is/are to be installed on an installation site having large installation area. This is superior to the panel solar cell module which has to be transported in the same shape as when it is to be installed.

Incidentally, as for dye-sensitized solar cells, the panel dye-sensitized solar cell has been partly put into practical use. On the other hand, the cylindrical dye-sensitized solar cell is currently at a stage of research and development, and no specific proposal has been made yet on a configuration of a module in practical use of the cylindrical dye-sensitized solar cell. In view of the configuration of the module for the practical use of the cylindrical dye-sensitized solar cell, easy transportation and installation are important factors.

The following drawbacks may be contemplated as to the transportation and the installation of the panel solar cell.

(1) The panel solar cells may be provided as a module. However, such a panel solar cell module results in a configuration in which the panel solar cells are arrayed and fixed on the same plane, which generally leads to handling on a mass scale easily. An increased size of the module for achieving a certain amount of power generation may lead to extensive packaging when carrying the module from a place of manufacture of the panels to a place where the module is to be installed (used), or may lead to expensive transportation costs due to the necessity of preparing large transporting devices and areas for storage.

(2) The panel solar cell module has the configuration in which the panel solar cells are arrayed on the same plane and thus has a shape of a flat plate as a whole, and the flat plate shape is maintained by a frame having high rigidity. Although installation of such a panel solar cell module is relatively easy for a place such as a planar roof, the installation thereof is difficult for non-planar installation sites such as a roof and a wall surface that are curved. For example, when installing the panel solar cell module on the curved roof, it is necessary to provide on the roof a structure that includes legs and beams for retaining the module, and to fix the frame of the module to the structure. This tends to increase installation costs in the case of installing the panel solar cell module on non-planar installation sites.

(3) The panel solar cell module is flat-plate in shape as a whole and thus susceptible to an influence of wind. Hence, it is necessary that the installation be robust in order to prevent damage caused by application of strong wind such as hurricane, which results in expensive installation costs. This is prominent when the module is installed off the roof or the wall surface as in the installation on a rooftop of a building. Although the structure that includes the legs and beams is provided to install the module thereto, the module is likely to be fanned by the wind and hence strong structure is desirable.

It is therefore desirable that drawbacks associated with the panel solar cell module be overcome for achieving a module of the cylindrical solar cells including the cylindrical dye-sensitized solar cells. The present embodiment of the invention thus aims to provide a solar cell module in which cylindrical solar cells are used and which is high in degree of freedom as to selection of installation sites, easy to transport and install, and inexpensive.

According to the first embodiment as described above, the plurality of cylindrical solar cells are so retained as to be separated away from one another, making it possible to increase conversion efficiency per region in an installation site. Also, light is allowed to pass through a clearance between the cylindrical solar cells, making it possible to install the module at any location where collection of light is necessary. Further, wind is allowed to pass through the clearance between the cylindrical solar cells, making it possible for the module to be less susceptible to wind as compared with a panel solar cell module. Hence, it is possible to make installation costs inexpensive. Additionally, each of the cylindrical solar cells is displaceable relative to adjacent another cylindrical solar cell, making it possible to increase a degree of freedom as to a shape of an installation site, and to perform installation at low cost even for a curved surface.

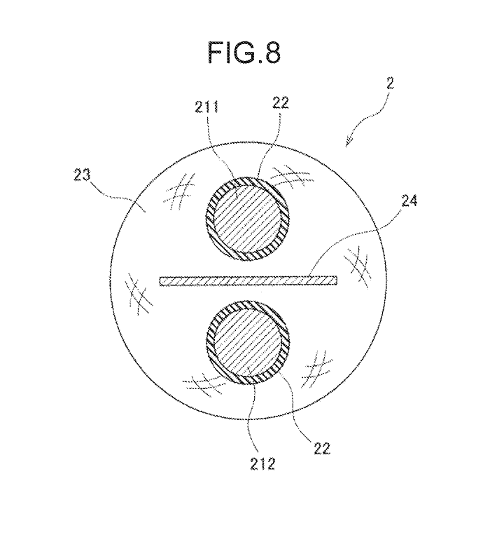

Next, a description is given of a solar cell module according to a second embodiment of the invention. FIG. 8 illustrates a distinctive part of the solar cell module according to the second embodiment. In the second embodiment, the wire 2 serves as the retaining member as with the example embodiment described above, a cross-sectional shape of which is illustrated in FIG. 8.

The second embodiment differs from the first embodiment in which the retaining member is the wire 2 having a single line, in that the retaining member is the wire 2 having double lines. Referring to FIG. 8, the wire 2 includes a pair of cores 211 and 212, the insulation coating 22, and the reinforcement sheath 23. The insulation coating 22 covers each of the cores 211 and 212, and the reinforcement sheath 23 is so provided as to surround the cores 211 and 212. Also, an insulation sheet 24 is interposed between the cores 211 and 212 to increase insulation therebetween.

The reinforcement sheath 23 may be the wrap of the steal thin wires stranded around the cores 211 and 212 each covered with the insulating coating 22, as with the first embodiment described above. In one embodiment, a configuration may be employed obtained by forming the insulation coating 22 at a certain thickness on each of the cores 211 and 212, followed by overlaying those cores 211 and 212 while interposing the insulation sheet 24 therebetween and so providing the steel thin wires, i.e., the reinforcement sheath 23, as to surround the cores 211 and 212 in their entirety to reinforce the wire 2.

The cylindrical cells 1 are coupled to the wire 2 of the second embodiment thus configured as described above, through the use of the same configuration as the first embodiment. The cylindrical cell 1 is inserted into the cushion section 35 and may be adhered thereto so that the lead 16 is inserted into the socket 33, thereby being integral with the connector 3. Also, the wire 2, which may be the retaining member in the second embodiment, is interposed between the upper cover 311 and the lower cover 312 of the connector 3. The upper cover 311 and the lower cover 312 are closed to bring the engaging section 314 into the engaged state, which in turn causes the wire 2 to be swaged and thus crimped by the first crimping section 321 and the second crimping section 322 and brings the cylindrical cell 1 into electric conduction. One of such cores 211 and 212 serves as a positive polarity line (plus line) and the other serves as a negative polarity line (minus line). In one embodiment, when defining the core 211 located on the upper side as the plus line and bringing the cylindrical cell 1 into electrical conduction with that plus line, the connector 3 and the cylindrical cell 1 are coupled to the wire 2 in the same approach as illustrated in FIG. 5. When bringing the cylindrical cell 1 into electrical conduction with the minus line, the connector 3 and the cylindrical cell 1 are reversed upside down, and the connector 3 and the cylindrical cell 1 are coupled to the wire 2 while the socket 33 is electrically connected to the minus line.

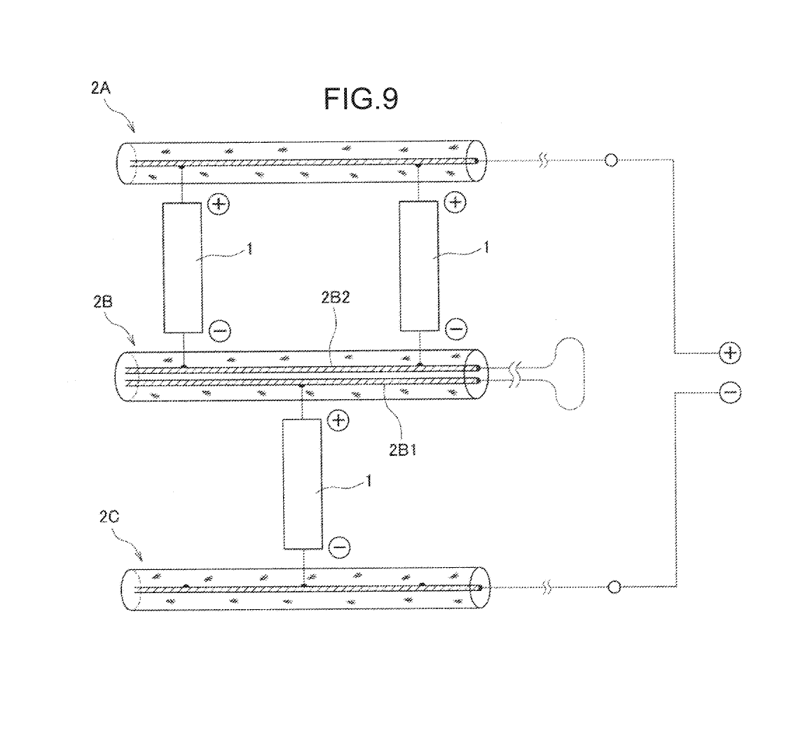

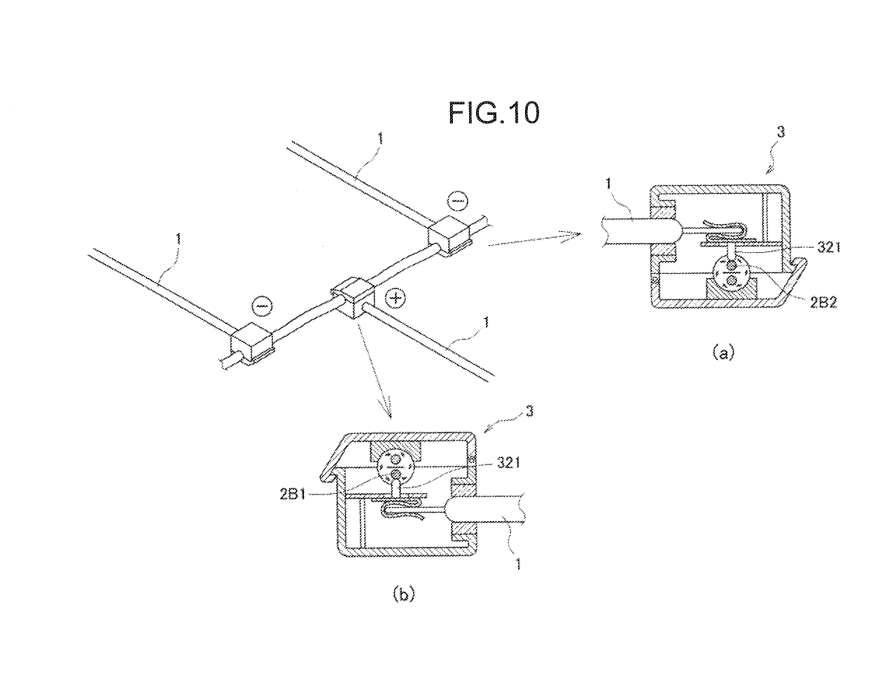

In the second embodiment, the wire 2 serving as the retaining member is based on the double-line scheme, allowing for a parallel connection, a serial connection, or a combination thereof of the cylindrical cells 1. Various array patterns are thus adoptable as to the connection of the cylindrical cells 1, some examples of which are described referring to FIGS. 9 and 10. FIG. 9 schematically illustrates an example of an array pattern of the cylindrical solar cells in the solar cell module according to the second embodiment. FIG. 10 is a schematic cross-sectional view illustrating retaining structures of the cylindrical solar cells in the array pattern illustrated in FIG. 9.

The solar cell module having the array pattern illustrated in FIGS. 9 and 10 includes three wires each serving as the retaining member and are hereinafter referred to as a first wire 2A, a second wire 2B, and a third wire 2C. The cylindrical cells 1 are so arrayed and retained, while being separated away from one another, as to be installed between the first wire 2A and the second wire 2B. The cylindrical cells 1 are also arrayed and retained between the second wire 2B and the third wire 2C.

The cylindrical cells 1 belonging to a first group, defined by those that are arrayed between the first wire 2A and the second wire 2B, are arrayed and retained such that the respective leads having the negative polarity are connected to a minus line 2B2 of the second wire 2B, and the cylindrical cells 1 belonging to a second group, defined by those that are arrayed between the second wire 2B and the third wire 2C, are arrayed and retained such that the respective leads having the positive polarity are connected to a plus line 2B1 of the second wire 2B, as illustrated schematically in FIG. 9.

Further, as illustrated in FIG. 9, the minus line 2B2 and the plus line 2B1 in the second wire 2B are connected to each other. Hence, the solar cell module illustrated in FIG. 9 has a configuration in which the first group cylindrical cells 1 arrayed in parallel connection and the second group cylindrical cells 1 arrayed in parallel connection are connected in series.

The retaining structure of each of the cylindrical cells 1 is similar to that described above and thus uses the connector 3, with the exception that a direction of the coupling requires selection so that the polarities are matched with predetermined ones for the second wire 2B. The second wire 2B is disposed such that the minus line 2B2 is located above and the plus line 2B1 is located below, and the connector 3 provided for each of the cylindrical cells 1 belonging to the first group is disposed such that the first crimping section 321 is electrically connected to the minus line 2B2 on the upper side, as illustrated in (a) of FIG. 10 in an enlarged manner. On the other hand, each of the cylindrical cells 1 belonging to the second group is disposed upside down contrary to the cylindrical cells 1 belonging to the first group, i.e., the connector 3 provided for each of the cylindrical cells 1 belonging to the second group is connected to the wire 2 such that the first crimping section 321 inside the connector 3 is protruded from the lower side to the upper side to reach the plus line 2B1 located below the minus line 2B2 to be electrically connected to the plus line 2B1, as illustrated in (b) of FIG. 10 in an enlarged manner. It is to be noted that the first wire 2A and the third wire 2C are both based on the single-line scheme, allowing the first crimping section 321 to be electrically connected to the core 21 from any of the upper side and the lower side.

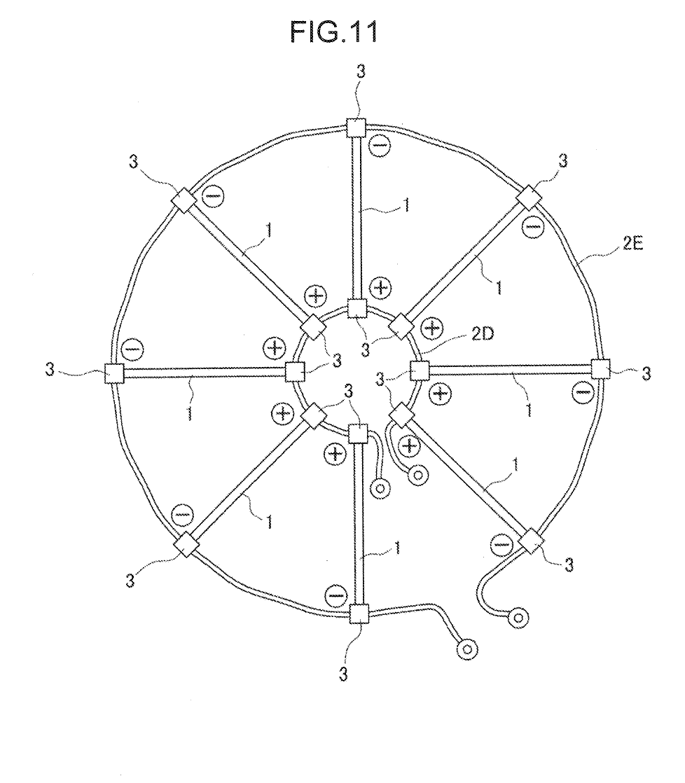

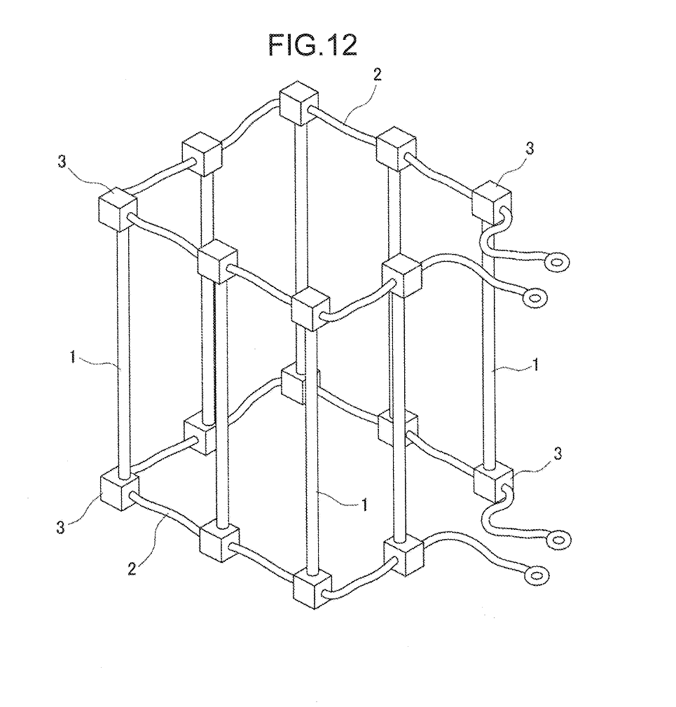

FIGS. 11 and 12 illustrate some other examples of the array pattern. FIGS. 11 and 12 each schematically illustrate another example of the array pattern of the cylindrical solar cells 1.

FIG. 11 illustrates an example of a configuration in which the cylindrical cells 1 are arrayed radially. In this embodiment, the cylindrical cells 1 are connected in parallel, and may be so arrayed as to point the respective positive polarity sides toward the center. Each of the cylindrical cells 1 is retained by a wire 2D that forms a smaller circle on the center side, and is retained by a wire 2E that forms a larger circle on the outer side. For example, the configuration illustrated in FIG. 11 may be applicable to an installation on a conical roof or a roof having a shape of an umbrella.

FIG. 12 illustrates an example of a configuration in which the cylindrical cells 1 are three-dimensionally arrayed. In this embodiment, the cylindrical cells 1 may be disposed at respective locations equivalent to mutually-parallel four sides of a cuboid, and also at respective locations each substantially in the middle of the adjacent two sides thereof. The cylindrical cells 1 are parallel with one another. The wires 2 are arranged on the upper side and on the lower side, and retain the both ends on the upper side and on the lower side of the respective cylindrical cells 1 through the connectors 3. One of the wires 2 retains the cylindrical cells 1 at the respective positive polarity sides thereof, whereas the other wire 2 retains those cylindrical cells 1 at the respective negative polarity sides, thus electrically connecting the cylindrical cells 1 in parallel. For example, the configuration illustrated in FIG. 12 allows for an installation in which the solar cell module according to the present embodiment is wrapped around a pillar which may have a shape of a square bar. Also, in one embodiment, a plurality of solar cell modules each having the arrangement as illustrated in FIG. 12 may be provided vertically and connected in series to one another.

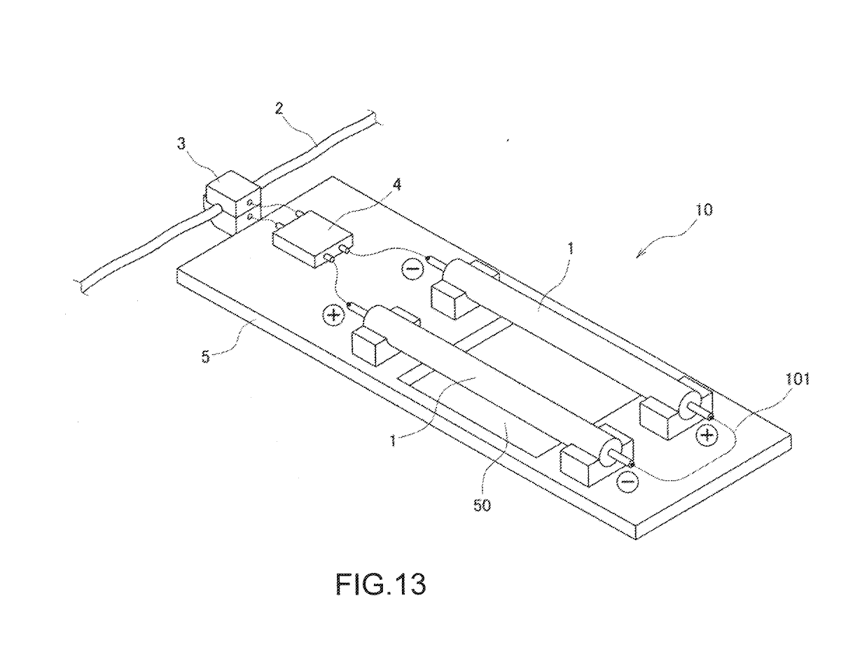

Next, a description is given of a solar cell module according to a third embodiment of the invention. FIG. 13 is a schematic perspective view illustrating a distinctive part of the solar cell module according to the third embodiment.

The third embodiment differs from the first embodiment in that two cylindrical cells form an unit and are retained by the retaining member on an unit basis (hereinafter referred to as a “cell unit”), and that the cylindrical cells are retained by the retaining member while being connected to a converter.

Referring to FIG. 13, a cell unit 10 includes the two cylindrical cells 1 arranged side-by-side, and a converter 4. The two cylindrical cells 1 and the converter 4 are fixed on a base plate 5 which may have an elongated rectangular shape. The base plate 5 has an opening 50, allowing sunlight to be impinged onto each of the cylindrical cells 1 also from the backside of the base plate 50 through the opening 50.

The two cylindrical cells 1 are connected in series through a wiring 101, and an output of such series-connected two cylindrical cells 1 is connected to the converter 4. The converter 4 may be a DC-DC converter, and may convert an output voltage derived from the two cylindrical cells 1 into another direct-current voltage. In one embodiment where the cylindrical cells 1 are each a dye-sensitized solar cell in which an output derived from the single cylindrical cell 1 may be about 0.7 volts, the converter 4 may be that which converts an output at a total of about 1.4 volts into 5 volts output. Such a converter 4 may be a small-sized chip converter, non-limiting examples of which may include a low input voltage, synchronous step-up converter available from Texas Instruments located in Dallas, Tex., United States.

The retaining member may be the wire 2 based on the double-line scheme as illustrated in FIG. 8. The connector 3 is attached to the wire 2, and the converter 4 is connected to the wire 2 through the connector 3. The connector 3 may be fixed to the base plate 5 and may be provided integrally therewith. The connector 3 may have a configuration similar to that illustrated in FIG. 8.

The connector 3 has an unillustrated configuration substantially similar to the configuration illustrated in FIG. 8 with the exception that the socket 33 is omitted. A pair of crimping sections provided therein are both capable of cutting the reinforcement sheath 23 as with the first crimping section 321 illustrated in FIG. 5 to be electrically connected to the respective cores 211 and 212. One of the pair of crimping sections to be brought into contact with the plus line is electrically connected to a plus terminal of the converter 4 through a wiring, whereas the other of the crimping sections to be brought into contact with the minus line is electrically connected to a minus terminal of the converter 4 through a wiring. As described above, the upper cover 311 and the lower cover 312 are likewise closed to bring the engaging section 314 into the engaged state, which in turn brings the crimping sections to be in contact with the respective cores 211 and 212 and thus brings the cylindrical cells 1 into electric conduction. In one embodiment, a configuration may be employed in which the connector 3 is provided on the other end of the base plate 5 and the cylindrical cells 1 are retained by the wire 2 at the other end of the base plate 5 as well.

A plurality of such cell units 10 each having the configuration as described above are provided and are connected to the wire 2 through the respective connectors 3. In the third embodiment, the cell units 10 are connected in parallel. In one embodiment, however, a configuration may be employed in which the cell units 10 are connected in series.

In the third embodiment, each of the cell units 10 is displaceable relative to adjacent another cell unit 10, thereby making it possible to likewise achieve effects, such as, but not limited to, the increase in degree of freedom of installation sites and easier transportation and storage. In addition thereto, the two cylindrical cells 1 are arrayed in series to form one cell unit 10 that includes the converter 4, making it possible to derive a higher output voltage at a standardized value. Additionally, the cell unit 10 is provided attachably to and detachably from the wire 2, making it possible to perform replacement of only the desired cell unit 10.

Incidentally, effects that the higher output voltage is derived at a standardized value and the desired cell unit 10 is replaced are obtainable even if the retaining member that makes the cylindrical cells displaceable is unused. Hence, the configuration in which the cell unit configured of the series-connected cylindrical cells and the converter is provided attachably to and detachably from the retaining member may be regarded as the invention independent regardless of whether the cylindrical cell is displaceable or not.

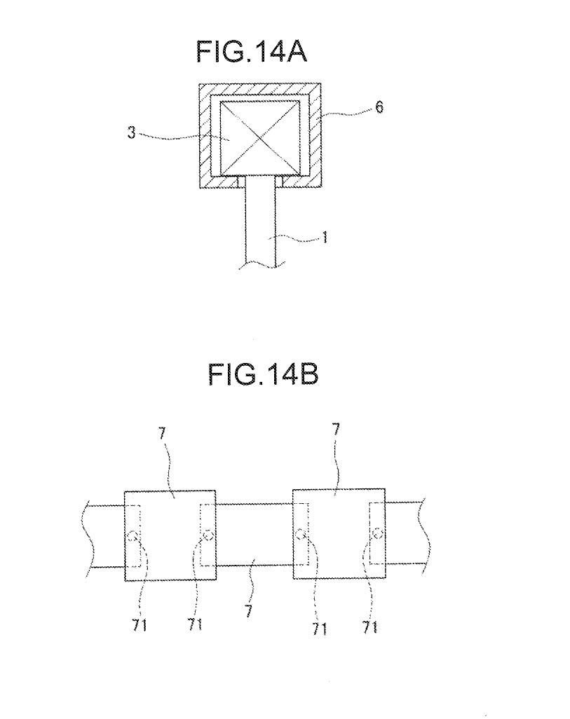

Next, a description is given of some other examples of the retaining member in the solar cell module according to any embodiment of the invention. FIGS. 14A and 14B schematically illustrate other examples of the retaining member.

In each of the example embodiments described above, the retaining member is the wire 2. However, the retaining member may be a belt. FIG. 14A illustrates one embodiment where the retaining member is a belt 6. The retaining member in such an embodiment may include a material and a configuration similar to those of a soft curtail rail made of a resin, commercially available under the name known as “bendable curtain rail”. The belt 6 has a shape of a rail that includes a portion having a shape of “U” substantially in cross section, and has a configuration in which the connector 3 is slidable like a runner of a curtain rail.

The connector 3 is fixed to the cylindrical cell 1 whose lead is inserted into the socket 33 provided in the connector 3. When coupling the cylindrical cell 1 to the belt 6, the connector 3 is inserted from an end (an open end) of the belt 6 as with the case of attaching a runner to a curtail rail, to allow the connector 3 and the cylindrical cell 1 to be integrally retained by the belt 6. Then, the connector 3 is slid along the belt 6 to move the cylindrical cell 1, and is stopped at any desired position to fix the cylindrical cell 1 at that position. The fixing may be performed using any method such as, but not limited to, screw fastening, swaging similar to using a crimping terminal, or adhesive bonding.

The belt 6 is a soft member made of a resin, although the belt 6 may be a member made of a plastic-deformable metal or a member having a configuration in which the plastic-deformable metal is covered with a resin. In either case, the belt 6 is deformable and is thus usable as the retaining member as with the wire 2.

Also, the belt 6 may have a function of conducting electricity. In such an embodiment, a configuration may be employed in which a wiring is provided inside a thick portion of the belt 6 and a terminal of the socket 33 is brought into contact with the wiring while penetrating the terminal through the thick portion upon attachment of the connector 3. In one embodiment, a configuration may be employed alternatively in which the cylindrical cell 1 is provided attachably to and detachably from the connector 3, and the cylindrical cell 1 is mounted to the connector 3 after the connector 3 is inserted into the belt 6.

FIG. 14B illustrates another example of the retaining member. In this embodiment, a structure in which a plurality of members are coupled together forms the retaining member as a whole. In the structure, block-shaped members (blocks) 7 having respective sizes different from one another are mutually coupled to form the retaining member as a whole. The blocks 7 are coupled to each other through a pin 71 serving as a rotation shaft, and thus are mutually rotatable around the pin 71. The pin 71 may be long in a direction perpendicular to a plane of the drawing in FIG. 14B.

Some of the blocks 7 may have a configuration in which the cylindrical cell 1 is mountable. For example, some of the blocks 7 may have a configuration, similar to that illustrated in FIG. 5, in which the socket 33 is provided therein. Such retaining members including the plurality of blocks 7 are provided to form a pair, and retain at both ends the cylindrical cells 1 that are arrayed in parallel to one another. In one embodiment, each of the blocks 7 may be mounted with and retain the cylindrical cell 1.

In the retaining member illustrated in FIG. 14B, a longitudinal direction of the pin 71 that couples the blocks 7 together corresponds to the longitudinal direction of the mounted cylindrical cell 1. Hence, it is possible to roll up the solar cell module as a whole to allow the solar cell module to be compact in dimension, as in the above-described embodiments of the wire 2 and the belt 6. In one embodiment where the retaining member illustrated in FIG. 14B also serves to conduct electricity, a configuration may be employed in which each of the blocks 7 may have a shape of a tube to place the blocks 7 into communication with one another through respective internal spaces, and a wiring is provided through those internal spaces.

As described in the foregoing, the cylindrical cells 1 are so provided as to be separated away from one another in the solar cell module according to any example embodiment, allowing the solar cell module to be attached suitably to a location such as, but not limited to, a roof or a wall that requires introduction of light. One non-limiting example is a green house such as a plastic green house. Considering attachment of the solar cell module to a roof, a wall, or both of the green house, the solar cell module according to any embodiment may be installed as a power source for a long-day adjustment. The wording “long-day adjustment” as used herein refers to adjustment to artificially lengthen the sunshine hours, which may be performed by allowing a long-hour light source provided in the greenhouse to be ON around sunrise or around sunset. In such an embodiment, the long-hour light source is provided in the greenhouse, and the solar cell module is connected to an electricity storage. The long-hour light source is connected to the electricity storage through a voltage adjuster. The electricity generated by the solar cell module is once stored in the electricity storage, and the stored electricity is supplied to the long-hour light source through the voltage adjuster. Turning on and off of the long-hour light source may be controlled in response to factors including timing of the sunrise and timing of the sunset.

The solar cell module according to any example embodiment described above may be attached to a pillar of a building. In such an embodiment, the retaining members may surround the pillar vertically and the cylindrical cells 1 may be arrayed along a length direction of the pillar so that the solar cell module as a whole is attached to the pillar.

The solar cell module according to any example embodiment may be suitably installed as described above on a pillar such as, but not limited to, that provided at an outdoor location or that provided at an indoor bright location including the inside of the greenhouse. As for the green house, it is not preferable in many cases to newly dig the ground to place a pillar for attachment of a device. The solar cell module according to any example embodiment is preferable in that the solar cell module is mountable to an existing pillar.

Although the invention has been described in the foregoing by way of example with reference to some example embodiments, the invention is not limited thereto but may be modified in a wide variety of ways.

For example, in each of the example embodiments described above, the cylindrical cell 1 may be a dye-sensitized solar cell. However, any other solar cell may be used as long as that solar cell is of a cylindrical type. For example, a cylindrical CIGS solar cell has been already put into practical use, which may be used as the cylindrical cell in any embodiment of the invention.

Also, in each of the example embodiments described above, the term “cylindrical” is intended to be construed broadly to encompass, by way of example and without limitation, not only “cylindrical” in a strict geometrical sense but also “cylindrical” which is ellipse in cross section, as the concept of “cylindrical” used herein. Further, the term “cylindrical” is intended to encompass both the cylindrical in the sense that the inside thereof is hollow and in the sense that the inside thereof is filled.

Furthermore, the invention encompasses any possible combination of some or all of the various embodiments described herein and incorporated herein.

It is possible to achieve at least the following configurations from the above-described example embodiments of the invention.
(1) A solar cell module, including:
   a plurality of cylindrical solar cells; and
   a retaining member configured to retain each of the cylindrical solar cells and couple the cylindrical solar cells together, the retaining member separating the cylindrical solar cells away from each other, and allowing any of the cylindrical solar cells to be displaced relative to adjacent one of the cylindrical solar cells.
(2) The solar cell module according to (1), wherein the retaining member includes a transmission path configured to send electricity generated by the cylindrical solar cells.
(3) The solar cell module according to (1) or (2), wherein the retaining member attachably and detachably retains the cylindrical solar cells.
(4) The solar cell module according to any one of (1) to (3), wherein the retaining member displaces the cylindrical solar cells to allow the solar cell module to be rolled up as a whole and the cylindrical solar cells to be bundled.
(5) The solar cell module according to (4), wherein the retaining member includes a wire.
(6) The solar cell module according to any one of (1) to (5), wherein
   the cylindrical solar cells form a plurality of cell units each including two of the cylindrical solar cells and a converter, the two cylindrical solar cells being connected in series, and the converter being configured to convert an output voltage derived from the two cylindrical solar cells, and
   the retaining member retains the cell units and couples the cell units together.
(7) The solar cell module according to any one of (1) to (6), wherein each of the cylindrical solar cells includes a dye-sensitized solar cell.

Although the invention has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. The term “substantially” and its variations are defined as being largely but not necessarily wholly what is specified as understood by one of ordinary skill in the art. The term “about” or “approximately” as used herein can allow for a degree of variability in a value or range. Moreover, no element or component in this disclosure is intended to be dedicated to the public regardless of whether the element or component is explicitly recited in the following claims.

What is claimed is:

1. A solar cell module, comprising:
a plurality of cylindrical solar cells; and
a retaining member configured to retain each of the cylindrical solar cells and couple the cylindrical solar cells together, the retaining member separating the cylindrical solar cells away from each other, and allowing any of the cylindrical solar cells to be displaced relative to adjacent one of the cylindrical solar cells.

2. The solar cell module according to claim 1, wherein the retaining member comprises a transmission path configured to send electricity generated by the cylindrical solar cells.

3. The solar cell module according to claim 1, wherein the retaining member attachably and detachably retains the cylindrical solar cells.

4. The solar cell module according to claim 1, wherein the retaining member displaces the cylindrical solar cells to allow the solar cell module to be rolled up as a whole and the cylindrical solar cells to be bundled.

5. The solar cell module according to claim 4, wherein the retaining member comprises a wire.

6. The solar cell module according to claim 1, wherein
the cylindrical solar cells form a plurality of cell units each including two of the cylindrical solar cells and a converter, the two cylindrical solar cells being connected in series, and the converter being configured to convert an output voltage derived from the two cylindrical solar cells, and
the retaining member retains the cell units and couples the cell units together.

7. The solar cell module according to claim 1, wherein each of the cylindrical solar cells comprises a dye-sensitized solar cell.
